(19) United States
(12) Patent Application Publication
(10) Pub. No.: US 2015/0366162 A1
(43) Pub. Date: Dec. 24, 2015

(54) Game Feeder

(71) Applicant: David Collins, Fort Myers, FL (US)

(72) Inventor: David Collins, Fort Myers, FL (US)

(21) Appl. No.: 14/841,999

(22) Filed: Sep. 1, 2015

Related U.S. Application Data
(63) Continuation of application No. 29/513,331, filed on Dec. 30, 2014, now Pat. No. D738051.
Application No. 29/513,331 is a continuation of application No. 13/661,510, filed on Oct. 26, 2012, now abandoned.

(51) Int. Cl. A01K 5/02

(52) U.S. Cl. CPC A01K 5/0225

(57) ABSTRACT

A game feeder includes a housing having a cavity, an input aperture, and an output aperture; a base attached to the housing; a spreader below the output aperture; and a motor attached to the feeder and the spreader and configured to rotate the spreader. The feeder can include a varmint guard disposed below the output aperture to restrict varmint access to the spreader and feeder.

### RELATED APPLICATION

This application is a continuation of application Ser. No. 29/513,331 filed Dec. 30, 2014, which is a continuation of application Ser. No. 13/661,510 filed Oct. 26, 2012.

### FIELD OF THE INVENTION

This invention relates to a game feeder.

### BACKGROUND OF THE INVENTION

Game feeders are used to attract game by providing feed for the game to consume.

### SUMMARY OF THE INVENTION

It is therefore an object of the present invention to provide a game feeder.

It is a further object of this invention to provide a game feeder having improved protection from vermin.

It is a further object of this invention to provide a game feeder that is more easily transportable.

An exemplary embodiment of the present invention can include a housing, a base, a spreader, and a motor. The following are exemplary aspects of the present invention:

a housing can be formed by one or more walls, that define a cavity, and can include an input aperture located on an upper portion of the housing and an output aperture located on a lower portion of the housing;

a base can have a top portion that can be securely attached to the housing, and a bottom portion configured to securely engage a ground surface;

a spreader can be located directly below the output aperture;

a motor can be securely attached to the game feeder and spreader, and can be configured to rotate the spreader when activated; and

when the spreader is rotated via the motor, the spreader can spread exhausted feed away from the spreader.

The following are optional exemplary aspects of the present invention:

a game feeder can further include a varmint guard, disposed directly below the output aperture, and securely attached to the housing such that the spreader is disposed between the varmint guard and the housing;

a varmint guard can include a plurality of guard holes;

a clearance distance between a varmint guard and the housing can be between about 3 inches and about 0.125 inches, in any measurable increment there between;

the spreader can be provided as a spreader plate having at least one tab for spreading the feed;

the motor can be disposed above the spreader and within the housing for varmint protection;

the base can be provided as a plurality of base components that are configured to securely connect together to form the base;

the plurality of base components can include a plurality of rails configured, to be aligned in parallel when the components are securely interconnected together, and to render the game feeder slidable along the ground surface;

the plurality of base components can further include a plurality of cross members configured to securely connect together at least two of the rails;

the plurality of base components can further include at least one cross element configured to securely connect together at least two of the plurality of cross members;

the lower portion of the housing can include a plurality of legs, and the base can include a plurality of leg extensions configured to securely engage the legs; and

a game feeder can further include one or more loops disposed on the upper portion of the housing for hanging the game feeder and/or disposed on the base for pulling the game feeder.

Another exemplary embodiment of the present invention can include a housing, a loop disposed on an upper portion of the housing for hanging the feeder from a structure, a spreader, and a motor.

Notably, any exemplary aspect illustrated, shown, or described herein, can be utilized optionally with any embodiment of the present invention.

These and other exemplary aspects of the present invention are described herein.

### BRIEF DESCRIPTION OF THE DRAWINGS

Other objects, features and advantages will occur from the following description of a preferred embodiment and the accompanying drawings, in which:

FIG. 1 is a lower, front and right side perspective view of the game feeder;

FIG. 2 is an upper, front and right side perspective view of the game feeder;

FIG. 3 is a left hand elevational view of the game feeder;

FIG. 4 is a rear elevational view of the game feeder;

FIG. 5 is a top plan view of the game feeder; and

FIG. 6 is a fragmentary lower perspective view of the spreader of the game feeder.

### DETAILED DESCRIPTION OF PREFERRED EMBODIMENTS

The invention will now be described in more detail by way of example with reference to the embodiment shown in the accompanying figures. It should be kept in mind that the following described embodiment is only presented by way of example and should not be construed as limiting the inventive concept to any particular physical configuration, material, or order. Further, exemplary embodiments and aspects between Figures are not to be construed in a limiting manner, and in particular, all combinations of all exemplary aspects are to be construed as embodiments independent of each other.

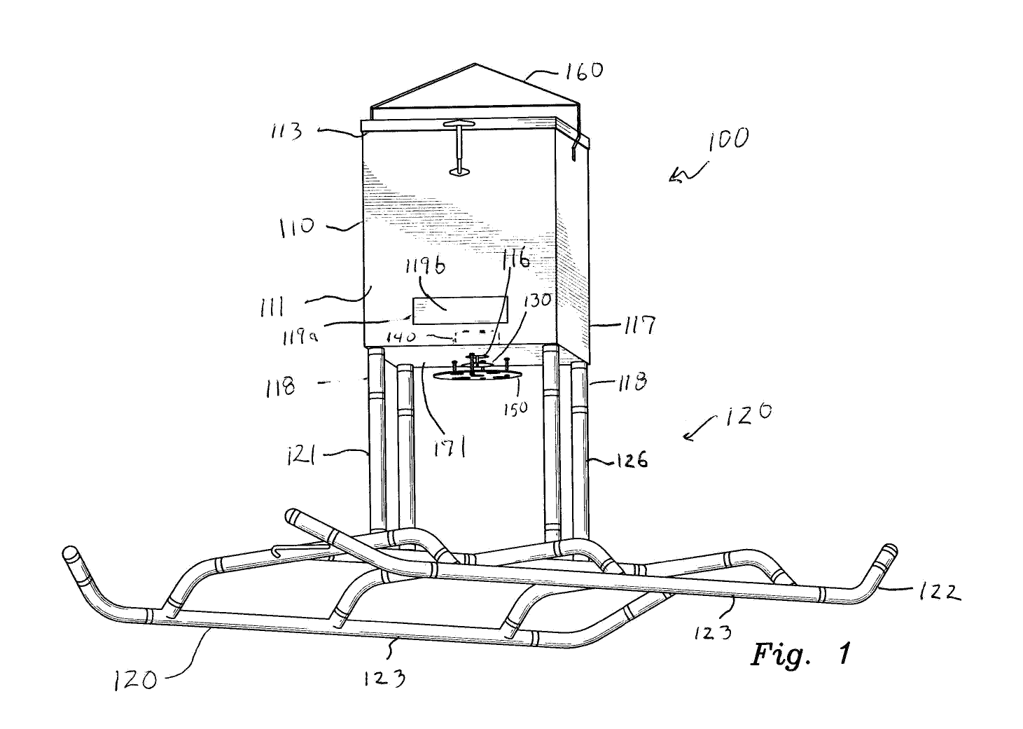

FIG. 1 illustrates an exemplary embodiment of the present invention, in which a game feeder 100 can include a housing 110, a base 120, a spreader 130, and a motor 140 above the spreader and inside housing 110.

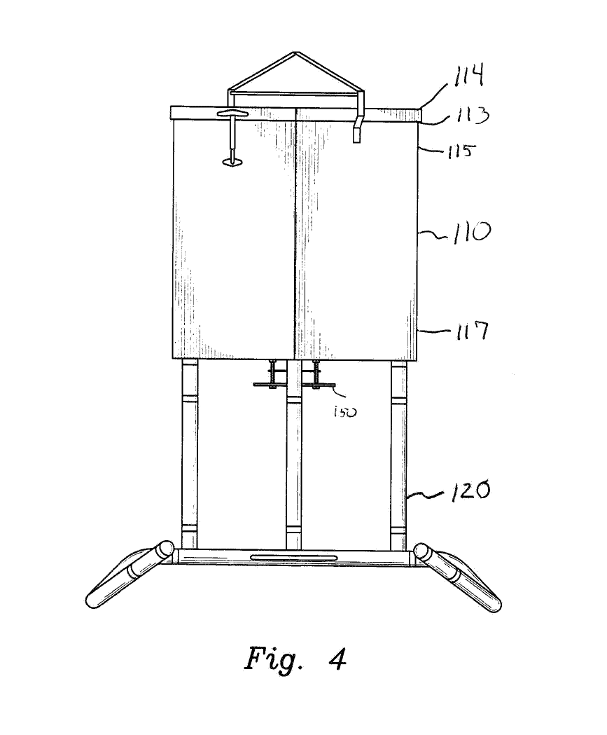

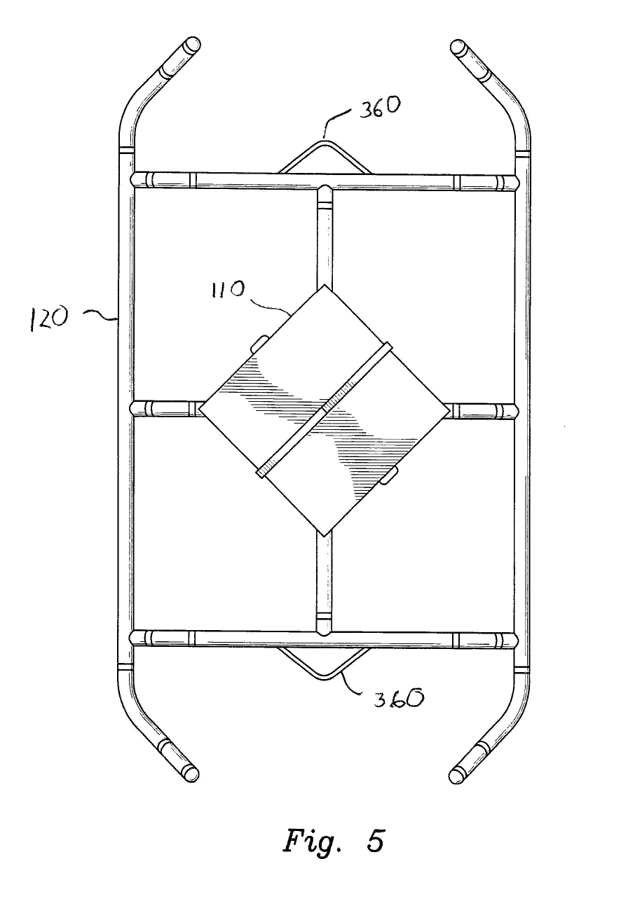

In an exemplary aspect of the present invention, housing 110 can be formed by four walls 111 and a bottom 171 that define a cavity. As illustrated in FIGS. 1-5, housing 110 is preferably constructed as a parallelepiped for improved stability. However, housing 110 can be provided as any one or more of, in whole or in part, a cube, prism, pyramid, sphere, cone, cylinder, or any other symmetrical and asymmetrical shape that is functionally compatible with the present invention.

As further illustrated in FIGS. 1-4, housing 110 can include an input aperture 113 having an optional input cover 114 located on an upper portion 115 of the housing, and an output aperture 116 located in bottom 171 of the housing. Cover 114 can be hingedly or slidably mounted to the inside or outside of housing 110, or configured to otherwise sealably engage housing 110. Input aperture 113 allows housing 110 to be filled with feed (not shown), and output aperture 116 allows feed to flow, via gravity, out of the housing cavity. Notably, output aperture 116 can optionally include an output cover (not shown) mounted to the inside or outside of housing 110, with an output cover being used to regulate the exhaust of feed through the output aperture. Further, housing 110 can optionally include a plurality of legs 118 at respective corners of the housing. These legs attach to base 120 and/or provide structure for engaging the ground insofar as desired.

As also illustrated in FIG. 1, base 120 can have a top portion 121 that can be securely attached to housing 110, and a bottom portion 122 that can securely engage a ground surface (not shown). Illustratively, top portion 121 can attach to a plurality of optional legs 118 of housing 110, or alternatively, attach directly to housing 110 in any functionally compatible manner, for example and not in limitation, by welding, bolt-nut combinations, or any other known or apparent connection structure(s) that are functionally consistent with the present invention.

FIG. 1 further illustrates a spreader 130 located directly below output aperture 116 and supported by a shaft 129 extending through aperture 116. Spreader 130 can be provided in any shape that is functionally compatible with the present invention, such that the spreader spreads feed exhausted from receptacle 116 of housing 110.

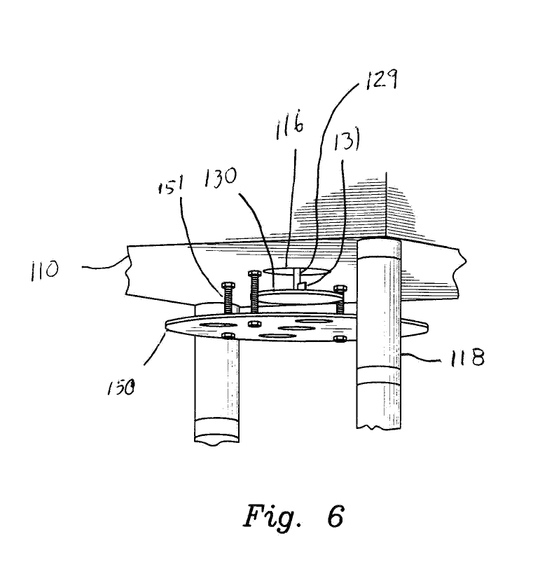

FIG. 6 illustrates further exemplary aspects of the present invention. For example and not in limitation, spreader 130 can be provided as an at least substantially flat plate; however, spreader 130 can alternatively be provided in any functionally compatible shape desired that is functionally consistent with the present invention. For example, and not in limitation, spreader 130 can be provided as a single tab or sweep arm carried on a plate as illustrated in FIG. 6. In an exemplary aspect, spreader 120 can include one or more tabs 131 (i.e., sweep arms) that can apply a force to exhausted feed when the spreader is rotated, resulting in such feed being spread away from the spreader.

A motor 140 can be securely attached to game feeder 100 and to spreader 130 within the housing and above the spreader, and configured in a known manner to rotate the spreader when activated. The motor is supported above aperture 116 sufficiently so as not to interfere with gravity flow of the feed through the lower aperture. Mounting the motor inside of housing 110 protects it against damage by varmints; and in such a case, housing 110 can include an optional access aperture 119a and access cover 119b, with the later being mounted to the inside or outside of housing 110. Motors of the type conventionally used in the game feeder art may be employed within the scope of this invention.

In exemplary operational aspects of game feeder 100, housing 110 can be filled with feed via input aperture 113. Feed can comprise particles having more one or more of various sizes. Exemplary feed types can include one or more of corn kernels, pellets, nuts, and various other man-made or naturally-occurring particles or liquids. Upon filling, feed can be gravity-biased to exhaust through output aperture 116 and abut spreader 130, which when not rotating, can provide an abutment structure that temporarily terminates such exhaust until spreader 130 is rotated. When spreader 130 is rotated by the motor, the spreader can spread exhausted feed away from the spreader, such that the feed can attract and be consumed by game.

Game feeder 100 can optionally include a varmint guard 150 disposed directly below output aperture 116 and securely attached to housing 110, such that spreader 130 is disposed between the varmint guard and the housing. As illustrated in FIG. 6, varmint guard 150 can optionally include a plurality of guard holes 251 which in one exemplary aspect, can allow fed to fall therethrough. The varmint guard is preferably a flat plate attached to bottom 131 of housing 110 by threaded connector elements such as bolts 151 and attached nuts. The varmint guard is oriented parallel to the bottom 171 of housing 110. Otherwise spreader 130 is fully exposed below housing 110. This configuration effectively blocks varmint access to aperture 116 and, at the same time, allows seed to be effectively disposed.

In still a further exemplary aspect, a clearance distance between varmint guard 150 and housing 110 can be minimized so as to allow rotation of spreader 130 and spreading of the feed, but also to prevent or reduce the accessibility or potential damage to spreader 130 by a varmint. For example and not in limitation, where feed particles are no greater than 0.125 inches, the clearance distance can be about 0.125 inches. It should be noted that the existence of spreader 130 between varmint guard 150 and housing 110 can be considered, and thus, spreader 130 can be provided with a minimal thickness that does not necessitate a greater clearance distance that needed to allow feed to be spread. In another exemplary aspect, a clearance distance can be between about 0.125 inches and about 3.0 includes, and in any measurable increment there between. Further, notably, varmint guard 150 can be attached to housing 110 in any apparent manner that allows a clearance distance to be adjustable. For example and not in limitation, varmint guard 150 can be attached to housing 110 via threaded elements, such as bolts 151, which can be rotated increase or decrease the clearance distance.

In another exemplary aspect, base 120 can be provided as a single formed unit, or can be provided as a plurality of base components that are configured to securely connect together to form the base. Connection can be effectuated in any functionally compatible manner, such as, for example and not in limitation, by bolt-nut combinations, clamps, and/or complementarily shaped connection points, etc. Notably, this latter aspect can improve transportation and/or storage of game feeder 100, includes but not limited to, shipping.

As further illustrated in FIG. 1, base 120 can include a plurality of rails 123 that can be configured to be aligned in parallel when the components are securely connected together, which can render the game feeder more easily slidable along a ground surface. Base 320 can include one or more cross members 324 configured to securely connect together at least two rails 323. As additionally illustrated, base 320 can include at least one cross element 325 configured to securely connect together at least two cross members 324.

As further illustrated in FIG. 1, and noted above, in another exemplary aspect, lower portion 117 of housing 110 can optionally include a plurality of legs 118, with base 120 having a plurality of leg extensions 126 configured to securely engage legs 118. Base 120 may releasably interconnect with legs 118.

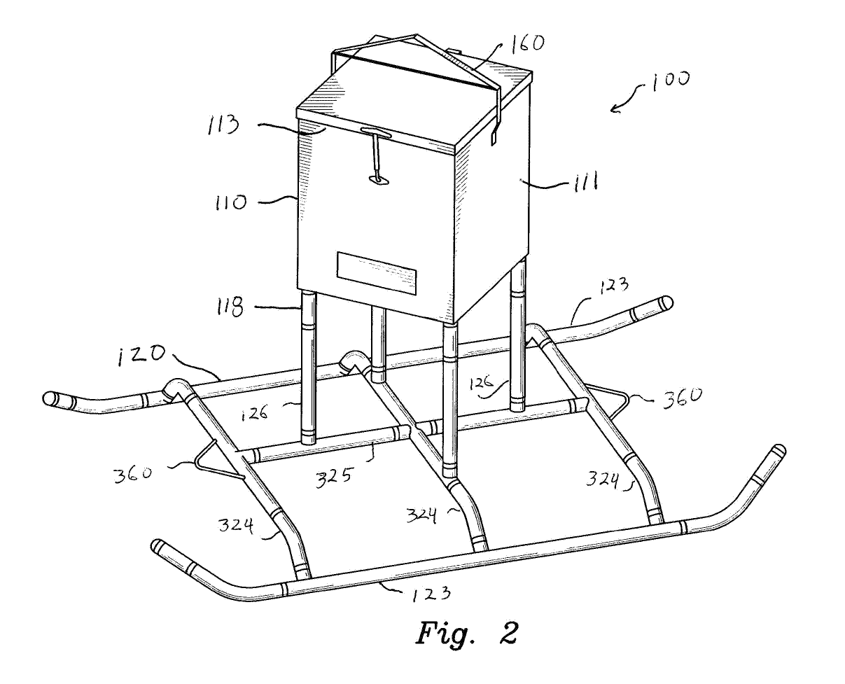

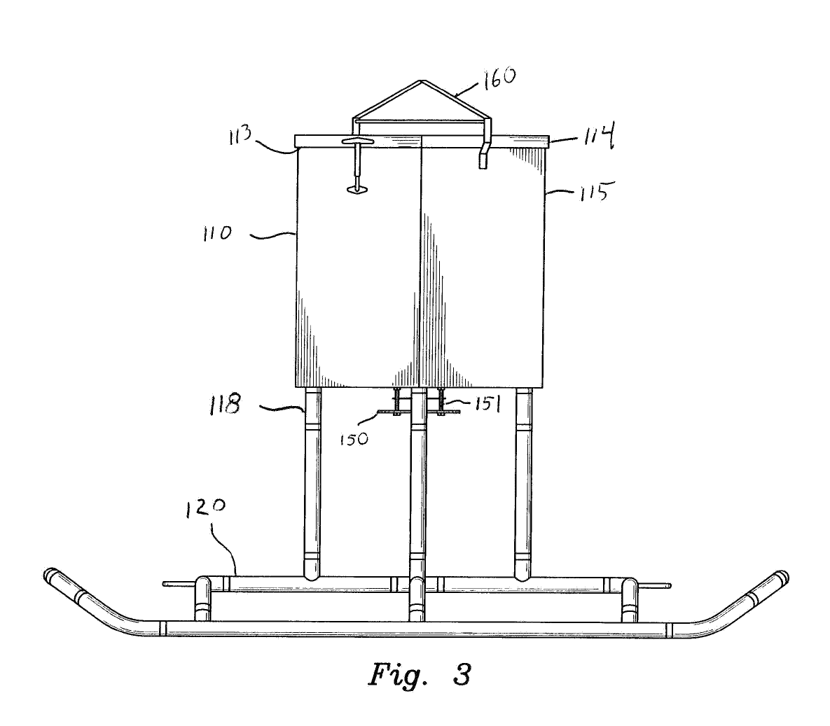

As further illustrated in FIG. 3, game feeder 100 can further include at least one loop 160 disposed on upper portion 115 of housing 110 for hanging the game feeder from a structure , such as for example and not in limitation, a tree, a stand, etc. Alternatively or conjunctively, as illustrated in FIG. 2, game feeder 130 can optionally include at least one loop 360 on base 320 for providing a pulling structure for the game feeder, which can render the game feeder more easily movable via pulling.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention. Moreover, particular exemplary features described herein in conjunction with specific embodiments and/or aspects of the present invention are to be construed as applicable to any embodiment described within, enabled hereby, or apparent herefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptions, and the same are intended to be comprehended within the meaning and range of equivalents of the appended claims.

From the foregoing it may be seen that the apparatus of this invention provides for a game feeder. While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

Other embodiments will occur to those skilled in the art and are within the following claims:

Therefore, I claim:

1. A game feeder comprising:
a parallelepiped shaped housing having an input aperture disposed on an upper portion of said housing and an output aperture disposed on a lower portion of said housing;
a base having a top portion securely attached to said housing, and a bottom portion configured to securely engage a ground surface;
a spreader disposed directly below the output aperture;
a varmint guard disposed below the output aperture and securely attached to said housing below, such that said spreader is disposed between said varmint guard and said housing; and
a motor attached to said game feeder and to said spreader and located within said housing above said spreader and said varmint guard; said motor configured to rotate said spreader when activated;
wherein when said housing is filled with feed via the input aperture, the feed is gravity-biased to exhaust through said output aperture such that when said spreader is rotated by said motor, said spreader spreads exhausted feed away from said spreader.

2. The game feeder of claim 1 wherein said varmint guard includes a plurality of guard holes.

3. The game feeder of claim 1 the varmint guard includes a flat plate oriented parallel to a bottom of said housing.

4. The game feeder of claim 1 wherein said spreader is a spreader plate having at least one tab.

5. The game feeder of claim 14 wherein said base includes a plurality of rails configured to be aligned in parallel when said plurality of components is securely connected together, and to render the game feeder slidable along the ground surface.

6. The game feeder of claim 5 wherein said base includes a plurality of cross members configured to securely connect together at least two of said plurality of rails.

7. The game feeder of claim 6 wherein said base further includes at least one cross element configured to securely connect together at least two of the plurality of cross members.

8. The game feeder of claim 1 wherein the lower portion of said housing includes a plurality of legs and said base includes a plurality of leg extensions configured to securely engage said legs.

9. The game feeder of claim 1 further comprising one or more loops disposed on at least one of the upper portion of said housing for hanging the game feeder and said base, for pulling the game feeder.

10. A game feeder comprising:
a parallelepiped shaped housing having a lid attached at an upper end of said housing and an output aperture formed in a bottom of said housing;
a base attached to said housing for supporting said housing;
a spreader disposed directly below said output aperture and supported by a shaft that extends through said output aperture; and
a varmint guard including a planar element that is attached to said bottom of said housing by a plurality of elongate connectors such that said spreader is disposed between said bottom of said housing and an upper surface of said varmint guard and said spreader is otherwise fully exposed below said housing.

11. The game feeder of claim 10 in which said elongate connector elements include threaded bolts and attached nuts for adjusting the distance between said varmint guard and said bottom of said housing.

12. The game feeder of claim 11 in which said varmint guard extends parallel to said bottom of said housing.
